(19) United States
(12) Patent Application Publication
(10) Pub. No.: US 2023/0227019 A1
(43) Pub. Date: Jul. 20, 2023

(54) HYBRID ELECTRIC VEHICLE AND METHOD FOR CONTROLLING THE SAME

(71) Applicant: TOYOTA JIDOSHA KABUSHIKI KAISHA, Toyota-shi (JP)

(72) Inventor: Yuki OGAWA, Toyota-shi (JP)

(73) Assignee: TOYOTA JIDOSHA KABUSHIKI KAISHA, Toyota-shi (JP)

(21) Appl. No.: 17/953,784

(22) Filed: Sep. 27, 2022

(30) Foreign Application Priority Data
Jan. 14, 2022 (JP) 2022-004291

(51) Int. Cl. B60W 20/12; B60W 10/06; B60W 10/08

(52) U.S. Cl. CPC B60W 20/12; B60W 10/06; B60W 10/08; B60W 2510/244; B60W 2555/80; B60W 2556/50

(57) ABSTRACT

In a hybrid electric vehicle and a control method thereof, a predicted travel route is acquired, required travel energy required for the hybrid electric vehicle to travel in the specific section in an EV drive mode is specified when the predicted travel route includes a specific section where the hybrid electric vehicle is supposed to travel in the EV drive mode, a desired value for the remaining capacity of the battery is set based on the specified required travel energy, a drive mode to be executed from a plurality of drive modes is determined based on the relationship between the actual remaining capacity of the battery and the desired value, until the hybrid electric vehicle enters the specific section. Switching between the EV and an HV drive modes is prohibited, regardless of the relationship, when a predetermined time has not elapsed since the last switching of the drive mode.

### CROSS-REFERENCE TO RELATED APPLICATION

This application claims priority to Japanese Patent Application No. 2022-004291 filed on Jan. 14, 2022, incorporated herein by reference in its entirety.

### BACKGROUND

### 1. Technical Field

The technique disclosed in the specification describing the present disclosure relates to hybrid electric vehicles and methods for controlling the same.

### 2. Description of Related Art

Japanese Unexamined Patent Application Publication No. 2003-095042 (JP 2003-095042 A) describes a power generation system that is mounted on a vehicle. This power generation system includes a generator that is driven by an engine, a battery that can be charged by the generator, and a controller. The controller controls charging of the battery by the generator based on the content of a predicted travel route of a vehicle (e.g., city or suburban area, time of day of travel, etc.).

### SUMMARY

Hybrid electric vehicles equipped with a motor for traction and an engine are known in the art. Hybrid electric vehicles can selectively operate in a plurality of drive modes such as electric drive mode (hereinafter simply referred to as the “EV drive mode”) and hybrid drive mode (hereinafter simply referred to as the “HV drive mode”). As used herein, the EV drive mode refers to a drive mode in which the vehicle runs on the motor with the engine stopped, and the HV drive mode is a mode in which the vehicle runs on the engine and/or the motor with the engine in operation.

In recent years, there has been a movement to restrict travel of vehicles involving engine operation in specific areas such as city areas. It is strongly required that hybrid electric vehicles operate in the EV drive mode when they travel in such specific areas. The cruising range in the EV drive mode depends on the remaining capacity of the battery, and the battery cannot be charged while the vehicle is traveling in a specific area. Therefore, when a hybrid electric vehicle plans to travel in a specific area, it is necessary to increase the remaining capacity of the battery before the hybrid electric vehicle reaches the specific area.

In this respect, if a predicted travel route of the hybrid electric vehicle is known in advance, it can be grasped in advance that the hybrid electric vehicle will travel in a specific area. A specific section included in the specific area can be determined from the predicted travel route, and a desired value for the remaining capacity of the battery can be set based on the required travel energy required for the hybrid electric vehicle to travel on the specific section in the EV drive mode. For example, when the remaining capacity of the battery is larger than the desired value, the hybrid electric vehicle operates in the EV drive mode because the remaining capacity of the battery is large enough. On the other hand, when the remaining capacity of the battery is equal to or smaller than the desired value, the hybrid electric vehicle operates in the HV drive mode in order to reduce or avoid a decrease in remaining capacity of the battery. By causing the hybrid electric vehicle to operate in one of the drive modes based on the relationship between the remaining capacity of the battery and the desired value, the remaining capacity of the battery can be controlled so that the remaining capacity will be equal to or larger than the desired value when the hybrid electric vehicle enters the specific section. However, when, for example, the remaining capacity of the battery is close to the desired value, the drive mode may be frequently switched between the EV drive mode and the HV drive mode. Such frequent switching of the drive mode involves, for example, stopping and starting of the engine, and therefore may cause discomfort to a driver.

The present disclosure provides a technique for avoiding frequent switching of the drive mode in hybrid electric vehicles.

A first aspect of the present disclosure relates to a hybrid electric vehicle including a motor for traction, an engine, a battery, and a controller. The battery is configured to supply driving electric power to the motor and is configured to be charged with electric power generated by the motor. The controller is configured to be able to control the motor and the engine and is configured to selectively execute a plurality of drive modes. The drive modes include at least an EV drive mode in which the hybrid electric vehicle runs on the motor with the engine stopped, and a HV drive mode in which the hybrid electric vehicle runs on the engine and/or the motor with the engine in operation. The controller is also configured to be able to perform an acquiring process, a specifying process, a setting process, and a determining process. The acquiring process is a process of acquiring a predicted travel route. The specifying process is a process of, when the predicted travel route includes a specific section where the hybrid electric vehicle is supposed to travel in the EV drive mode, specifying required travel energy required for the hybrid electric vehicle to travel in the specific section in the EV drive mode. The setting process is a process of setting a desired value for a remaining capacity of the battery based on the specified required travel energy.

The determining process is a process of determining a drive mode to be executed from the drive modes based on a relationship between an actual remaining capacity of the battery and the desired value, until the hybrid electric vehicle enters the specific section. The controller is configured to, in the determining process, prohibit switching between the EV drive mode and the HV drive mode regardless of the relationship when a predetermined time has not elapsed since last switching of the drive mode.

In the hybrid electric vehicle of the first aspect, the controller may be configured to, in the determining process, prohibit switching from the EV drive mode to the HV drive mode regardless of the relationship when the hybrid electric vehicle is located at less than a predetermined distance from the specific section.

In the hybrid electric vehicle of the first aspect, the controller may be configured to, in the determining process, select the EV drive mode when the relationship is that the actual remaining capacity of the battery is at least larger than the desired value.

In the hybrid electric vehicle of the first aspect, the controller may be configured to, in the determining process, select the EV drive mode when the relationship is that the actual remaining capacity of the battery is larger than a threshold value, and select the HV drive mode when the relationship is that the actual remaining capacity of the battery is equal to or smaller than the threshold value, the threshold value being a sum of the desired value and a predetermined margin.

In the hybrid electric vehicle having the above first configuration, the HV drive mode may include a normal HV drive mode and a charging HV drive mode in which the battery is charged more than in the normal HV drive mode, and the controller may be configured to, in the determining process, select the normal HV drive mode when the relationship is that the actual remaining capacity of the battery is larger than the desired value, and select the charging HV drive mode instead of the normal HV drive mode when the relationship is that the actual remaining capacity of the battery is equal to or smaller than the desired value.

In the hybrid electric vehicle having the above first configuration, the controller may be configured to, in the determining process, also prohibit switching between the normal HV drive mode and the charging HV drive mode regardless of the relationship when the predetermined time has not elapsed since the last switching of the drive mode.

In the hybrid electric vehicle of the first aspect, the specific section may be a section included in a predetermined urban area, environmental control area, emissions control area, or noise control area.

In the hybrid electric vehicle of the first aspect, the controller may be configured to, when the hybrid electric vehicle enters the specific section, perform switching to the EV drive mode even when the predetermined time has not elapsed since the last switching of the drive mode.

A method for controlling a hybrid electric vehicle according to a second aspect of the present disclosure relates to a method for controlling a hybrid electric vehicle including a motor for traction, an engine, and a battery configured to supply driving electric power to the motor and configured to be charged with electric power generated by the motor. The method includes: (i) controlling the motor and the engine; (ii) selectively executing a plurality of drive modes, the drive modes including at least an EV drive mode in which the hybrid electric vehicle runs on the motor with the engine stopped, and a HV drive mode in which the hybrid electric vehicle runs on the engine and/or the motor with the engine in operation; (iii) acquiring a predicted travel route; (iv) when the predicted travel route includes a specific section where the hybrid electric vehicle is supposed to travel in the EV drive mode, specifying required travel energy required for the hybrid electric vehicle to travel in the specific section in the EV drive mode; (v) setting a desired value for a remaining capacity of the battery based on the specified required travel energy; (vi) determining a drive mode to be executed from the drive modes based on a relationship between an actual remaining capacity of the battery and the desired value, until the hybrid electric vehicle enters the specific section; and (vii) prohibiting switching between the EV drive mode and the HV drive mode regardless of the relationship when a predetermined time has not elapsed since last switching of the drive mode.

In the hybrid electric vehicle of the first aspect and its configuration and the method for controlling a hybrid electric vehicle of the second aspect, a drive mode to be executed is determined from the plurality of drive modes based on the relationship between the actual remaining capacity of the battery and the desired value. The remaining capacity of the battery can thus be controlled so that the remaining capacity will be equal to or larger than the desired value when the hybrid electric vehicle enters the specific section. Moreover, when the predetermined time has not elapsed since the last switching of the drive mode, switching between the EV drive mode and the HV drive mode is prohibited regardless of the relationship between the actual remaining capacity of the battery and the desired value. Therefore, frequent switching between the EV drive mode and the HV drive mode can be reduced or avoided even when, for example, the remaining capacity of the battery is close to the desired value. This can reduce or avoid causing discomfort to the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows the appearance of a vehicle according to an embodiment of the present disclosure;

FIG. 2 is a block diagram showing main configurations of the vehicle;

FIG. 3 is a flowchart showing an example of a series of control operations that is performed by a hybrid electronic control unit (ECU) of FIGS. 1 and 2 mounted on the vehicle 10, where “A” in FIG. 3 connects to “A” in FIG. 4, and “B” in FIG. 3 comes from “B” in FIG. 4;

FIG. 4 is a flowchart showing the example of the series of control operations that is performed by the hybrid ECU, where “A” in FIG. 4 comes from “A” in FIG. 3, and “B” in FIG. 4 connects to “B” in FIG. 3.

### DETAILED DESCRIPTION OF EMBODIMENTS

In one embodiment of the present technique, in a process of determining a drive mode, switching from an EV drive mode to an HV drive mode may be prohibited regardless of the relationship between the actual remaining capacity of a battery and a desired value, when a hybrid electric vehicle is located at less than a predetermined distance from a specific section. The hybrid electric vehicle of the present technique is configured to travel in the EV drive mode in the specific section. For example, in the case where the hybrid electric vehicle is traveling in the HV drive mode before it enters the specific section, switching to the EV drive mode is performed when the hybrid electric vehicle enters the specific section. Therefore, when switching from the EV drive mode to the HV drive mode is performed immediately before the hybrid electric vehicle enters the specific section based on the relationship between the actual remaining capacity of the battery and the desired value, switching to the EV drive mode will be performed again when the hybrid electric vehicle enters the specific section. In this regard, in the configuration described above, switching from the EV drive mode to the HV drive mode is prohibited when the distance from a point where the hybrid electric vehicle is located to the specific section is smaller than the predetermined distance, that is, immediately before the hybrid electric vehicle enters the specific section. Therefore, the drive mode can be avoided from being frequently switched immediately before the hybrid electric vehicle enters the specific section and when the hybrid electric vehicle enters the specific section.

In one embodiment of the present technique, in the process of determining a drive mode, the EV drive mode may be selected when the relationship between the actual remaining capacity of the battery and the desired value is that the actual remaining capacity of the battery is at least larger than the desired value. According to this configuration, the amount of charge in the battery will be equal to or larger than the desired value when the hybrid electric vehicle enters the specific section. Moreover, the hybrid electric vehicle can travel in the EV drive mode in a section before the specific section when the remaining capacity of the battery is large enough. This can increase the energy efficiency of the hybrid electric vehicle.

In one embodiment of the present technique, in the process of determining a drive mode, the EV drive mode may be selected when the relationship between the actual remaining capacity of the battery and the desired value is that the actual remaining capacity of the battery is larger than a threshold value, and the HV drive mode may be selected when this relationship is that the actual remaining capacity of the battery is equal to or smaller than the threshold value, the threshold value being the sum of the desired value and a predetermined margin. According to this configuration, the amount of charge in the battery will be equal to or larger than the desired value when the hybrid electric vehicle enters the specific section. Moreover, the hybrid electric vehicle can travel in the EV drive mode in a section before the specific section when the remaining capacity of the battery is large enough.

In the above embodiment, the HV drive mode may include a normal HV drive mode and a charging HV drive mode in which the battery is charged more than in the normal HV drive mode. In this case, in the process of determining a drive mode, the normal HV drive mode may be selected when the relationship between the actual remaining capacity of the battery and the desired value is that the actual remaining capacity of the battery is larger than the desired value, and the charging HV drive mode may be selected instead of the normal HV drive mode when this relationship is that the actual remaining capacity of the battery is equal to or smaller than the desired value. This configuration can reduce or avoid a decrease in remaining capacity of the battery when the actual remaining capacity of the battery is equal to or smaller than the threshold value that is the sum of the desired value and the predetermined margin, and is larger than the desired value. This configuration can also increase the remaining capacity of the battery when the actual remaining capacity of the battery is equal to or smaller than the desired value. Accordingly, even when the remaining capacity of the battery is relatively small, the amount of charge in the battery will be equal to or larger than required travel energy when the hybrid electric vehicle enters the specific section.

In the above embodiment, in the process of determining a driving mode, switching between the normal HV drive mode and the charging HV drive mode may be prohibited regardless of the relationship between the actual remaining capacity of the battery and the desired value when a predetermined time has not elapsed since the last switching of the drive mode. According to this configuration, switching between the normal HV drive mode and the charging HV drive mode is permitted when the predetermined time has elapsed since the last switching of the drive mode. Depending on the configuration of the hybrid electric vehicle and/or the method for controlling the hybrid electric vehicle, a driver may be able to easily recognize the difference between the normal HV drive mode and the charging

HV drive mode from, for example, the operating state of the engine and the display of the drive mode on an instrument panel. In this case, this configuration can avoid causing discomfort to the driver by avoiding frequent switching between these drive modes. In another embodiment, even when the predetermined time has not elapsed since the last switching of the drive mode, switching between the normal HV drive mode and the charging

HV drive mode may be performed according to the relationship between the actual remaining capacity of the battery and the desired value.

In one embodiment of the present technique, the specific section may be a section included in a predetermined urban area, environmental control area, emissions control area, or noise control area. Urban areas, environmental control areas, emissions control areas, and noise control areas are all areas where travel of vehicles involving engine operation is restricted. Urban areas are areas provided in so-called city areas where commercial facilities, houses, etc. are densely located. Environmental control areas are areas having predetermined regulations for the purpose of reducing the environmental load from vehicles. Environmental control areas are sometimes designated in specific urban areas selected from the urban areas described above. Environmental control areas include, for example, emissions control areas and noise control areas. Emissions control areas are areas having regulations on the amount of exhaust gas emitted from vehicles. Noise control areas are areas having predetermined regulations on noise emitted from vehicles. For example, the predetermined regulations include that the loudness of noise emitted from vehicles is less than a predetermined value. Environmental control areas further include fuel economy control areas that are areas having regulations on fuel economy of vehicles, although the present disclosure is not limited to this. Environmental control areas (and each area included in the environmental control areas) may be temporarily designated according to the time of day, traffic conditions, etc.

In one embodiment of the present technique, when the hybrid electric vehicle enters the specific section, a controller may perform switching to the EV drive mode even when the predetermined time has not elapsed since the last switching of the drive mode. According to this configuration, even when a specific section appears in a predicted travel route of the hybrid electric vehicle due to, for example, the specific section being temporarily determined according to the time of day, traffic conditions, etc., the hybrid electric vehicle can travel in the EV drive mode when it enters the specific section.

A hybrid electric vehicle 10 (hereinafter simply referred to as the “vehicle 10”) of an embodiment will be described with reference to the drawings. The vehicle 10 of the present embodiment belongs to electrified vehicles having a motor 18 for driving wheels 14f, 14r, and is typically an electrified vehicle (so-called automobile) that travels on a road surface. However, a part or all of the technique described in the present embodiment can also be used for electrified vehicles that travel along a trajectory. The vehicle 10 is not limited to a vehicle that is driven by a user, and may be a vehicle that is remotely operated by an external device or an autonomous vehicle.

In the drawings, the direction FR indicates forward in the longitudinal direction of the vehicle 10, and the direction RR indicates rearward in the longitudinal direction of the vehicle 10. The direction UP indicates upward in the vertical direction of the vehicle 10, and the direction DW indicates downward in the vertical direction of the vehicle 10. In the present disclosure, the longitudinal direction of the vehicle 10, the lateral direction of the vehicle 10, and the vertical direction of the vehicle 10 are sometimes simply referred to as the longitudinal direction, the lateral direction, and the vertical direction, respectively.

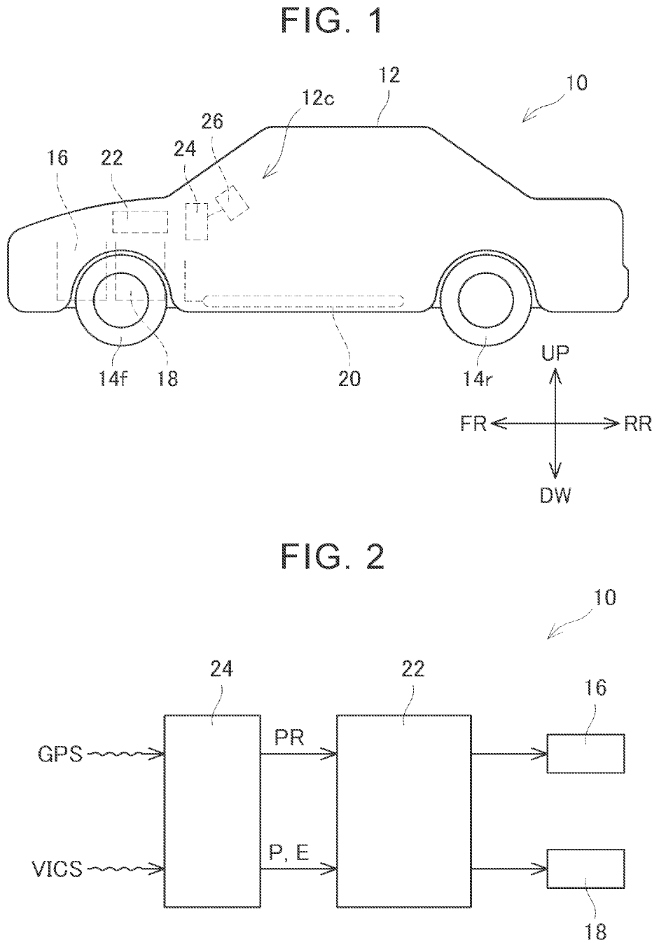

As shown in FIG. 1, the vehicle 10 includes a body 12 and a plurality of wheels 14f, 14r. The body 12 has a vehicle cabin 12c as a space for occupants. The wheels 14f, 14r are rotatably attached to the body 12. The wheels 14f, 14r include a pair of front wheels 14f located in the front part of the body 12 and a pair of rear wheels 14r located in the rear part of the body 12. The front wheels 14f are disposed coaxially with each other, and the rear wheels 14r are also disposed coaxially with each other. The number of wheels 14f, 14r is not limited to four. The body 12 is made of a metal such as steel or an aluminum alloy, although the present disclosure is not particularly limited to this.

As shown in FIGS. 1 and 2, the vehicle 10 further includes an engine 16 and a motor 18. The engine 16 is a heat engine that burns fuel to generate power, such as a gasoline engine or a diesel engine. The engine 16 is connected to the front wheels 14f, and can drive the front wheels 14f. The motor 18 is connected to the engine 16 via a power transmission path. The motor 18 is located between the engine 16 and the front wheels 14f, and can function as a motor that together with the engine 16 drives the front wheels 14f. The motor 18 can function not only as a motor but also as a generator. That is, the vehicle 10 can generate electricity with the motor 18 by driving the motor 18 by the engine 16. Alternatively, when the vehicle 10 needs to slow down on, for example, a downhill, the vehicle 10 can regeneratively brake the front wheels 14f by causing the motor 18 to function as a generator. A speed reducer or a clutch may be provided as necessary in a power transmission path between the engine 16 and the front wheels 14f. The engine 16 and the motor 18 need not necessarily drive the front wheels 14f The engine 16 and the motor 18 need only be configured to drive at least one of the wheels 14f, 14r.

As shown in FIG. 1, the vehicle 10 further includes a battery 20. The battery 20 includes a plurality of secondary battery cells, and is configured to be repeatedly charged with external electric power. The battery 20 is connected to the motor 18 via a power converter (not shown). The battery 20 can supply driving electric power to the motor 18, and can also be charged with the electric power generated by the motor 18. The battery 20 is, but is not particularly limited to, a lithium-ion battery or a nickel metal hydride battery.

As shown in FIGS. 1 and 2, the vehicle 10 further includes a hybrid electronic control unit (ECU) 22. The hybrid ECU 22 is a controller that controls the vehicle 10. The hybrid ECU 22 is a computer device that includes a processor, a memory, etc. The hybrid ECU 22 is connected to the engine 16 and the motor 18 so that the hybrid ECU 22 can communicate with the engine 16 and the motor 18. The hybrid ECU 22 is configured to be able to control the operation of the engine 16 and motor 18. For example, operation information indicating an operation performed by the user and vehicle information indicating the state of the vehicle 10 are input to the hybrid ECU 22. The operation information is, for example, accelerator operation amount information indicating the operation amount of an accelerator pedal by the user, or brake depression force information indicating the brake operation amount by the user. The vehicle information is, for example, vehicle speed information indicating the speed of the vehicle 10 and battery information indicating the remaining capacity of the battery 20. The hybrid ECU 22 controls the operation of each part of the vehicle 10 according to the received operation information and vehicle information.

The hybrid ECU 22 can selectively execute a plurality of drive modes including an EV drive mode and an HV drive mode. The EV drive mode is a drive mode in which the vehicle 10 runs on the motor 18 with the engine 16 stopped. On the other hand, the HV drive mode is a drive mode in which the vehicle 10 runs on the engine 16 and/or the motor 18 with the engine 16 in operation. As an example, the HV drive mode includes a normal HV drive mode and a charging HV drive mode. In the charging HV drive mode, the operation of the engine 16 and motor 18 is controlled so that the battery 20 is charged more than in the normal HV drive mode. For example, in the charging HV drive mode, the power output from the engine 16 is supplied to the front wheels 14f, so that the vehicle 10 travels. In the charging HV drive mode, the power output from the engine 16 is also supplied to the motor 18, so that the battery 20 is charged with the electric power generated by the motor 18. As an example, the hybrid ECU 22 can display the current drive mode on an instrument panel mounted in the vehicle cabin 12c. This allows a driver of the vehicle 10 to be aware of the current drive mode.

As shown in FIGS. 1 and 2, the vehicle 10 further includes a navigation system electronic control unit (ECU) 24 (hereinafter simply referred to as the “navigation ECU 24”). The navigation ECU 24 is a computer device that includes a processor, a memory, etc. The navigation ECU 24 is configured to communicate with an external system via the Internet etc., and can acquire various kinds of information from the external system. For example, the navigation ECU 24 can acquire the current location of the vehicle 10 from a Global Positioning System (GPS). The navigation ECU 24 can acquire map information from an external server etc. and identify the current location of the vehicle 10 on the map information. As used herein, the map information includes information on areas where travel of the vehicle 10 involving the operation of the engine 16 is restricted (e.g., urban areas, environmental control areas, emissions control areas, and noise control areas), and geographical information (e.g., speed limits, distances, road types, and slopes). Environmental control areas (including emissions control areas, noise control areas, etc.) are sometimes designated in specific urban areas for the purpose of reducing the environmental load, or sometimes temporarily designated according to the time of day, traffic conditions, etc., although the present disclosure is not particularly limited to this. The navigation ECU 24 can also acquire traffic congestion information, traffic regulation information, traffic accident information, etc. from a traffic information center such as Vehicle Information and Communication System (VICS (registered trademark)) center. The navigation ECU 24 can display such various kinds of information on a display 26 of a navigation system mounted in the vehicle cabin 12c.

In addition to the above, the navigation ECU 24 can accept operations performed by the user via the display 26. For example, when the user enters a destination on the display 26, the navigation ECU 24 creates a predicted travel route PR from the current location of the vehicle 10 to the destination, and displays the predicted travel route PR on the display 26. The navigation ECU 24 need not necessarily create the predicted travel route PR based on the destination entered by the user. As an example, the navigation ECU 24 may create a predicted travel route PR along which the vehicle 10 is presumed to travel based on past travel data. The navigation ECU 24 also calculates required travel power P required for the vehicle 10 to travel through each point of the predicted travel route PR, based on the past travel data and/or the types, slopes, etc. of road surfaces included in the map information. As described above, the required travel power P is a value estimated based on the past travel data and/or the map information. In addition, the navigation ECU 24 can also calculate, for each of a plurality of sections of the predicted travel route PR, required travel energy E required for the vehicle 10 to travel in the section by, for example, accumulating the required travel powers P for the points in the predicted travel route PR.

The navigation ECU 24 is connected to the hybrid ECU 22 by Controller Area Network (CAN) communication so that the navigation ECU 24 can communicate with the hybrid ECU 22. The hybrid ECU 22 can thus acquire from the navigation ECU 24 various kinds of information including the predicted travel route PR, urban areas, environmental control areas, emissions control areas, noise control areas, and required travel energy E required for the vehicle 10 to travel in each section. The hybrid ECU 22 is configured to selectively execute a plurality of drive modes based on the various kinds of information acquired from the navigation ECU 24.

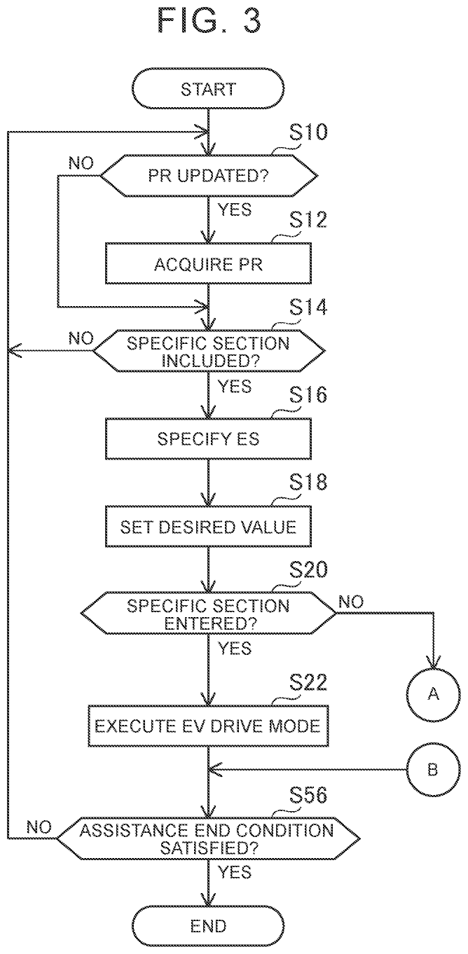

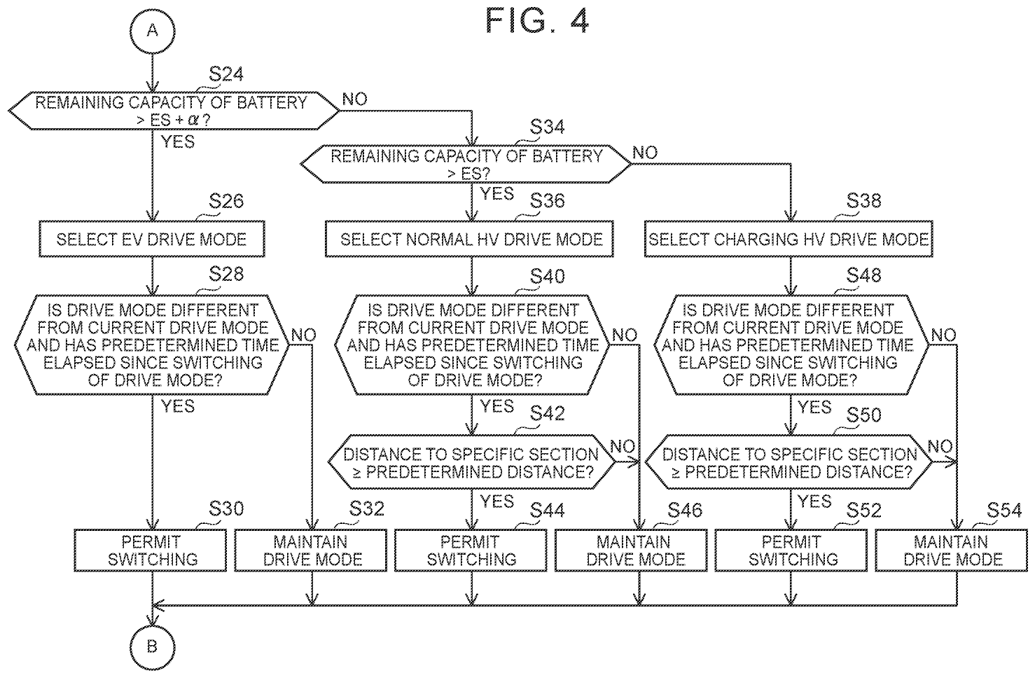

A specific example of the operation of the vehicle 10, namely a series of control operations that is performed by the hybrid ECU 22, will be described with reference to FIGS. 3 and 4. In this series of control operations, the hybrid ECU 22 assists the user in driving the vehicle 10 with high fuel efficiency by automatically switching the drive mode for the predicted travel route PR created by the navigation ECU 24. As described above, the predicted travel route PR is created by the navigation ECU 24 based on the destination specified by the user and the past travel data. The predicted travel route PR includes various kinds of information on the predicted travel route PR acquired by the navigation ECU 24 from the external server and the traffic information center, such as information on urban areas, environmental control areas, emissions control areas, and noise control areas, geographical information, traffic congestion information, traffic regulation information, and traffic accident information. The predicted travel route PR also includes the required travel energies E for each section of the predicted travel route PR. The navigation ECU 24 sends a predetermined notification to the hybrid ECU 22 when the predicted travel route PR has been newly created or updated according to, for example, an instruction or operation by the user. The hybrid ECU 22 is configured to perform the series of control operations shown in FIGS. 3 and 4 in response to the notification from the navigation ECU 24.

First, in step S10, the hybrid ECU 22 determines whether the predicted travel route PR has been updated. When the hybrid ECU 22 receives the predetermined notification from the navigation ECU 24 (YES in step S10), the hybrid ECU 22 acquires the updated predicted travel route PR from the navigation ECU 24 (step S12). In addition to the predicted travel route PR acquired by the hybrid ECU 22, the various kinds of information included in the predicted travel route PR are thus also updated. When NO in step S10, the routine skips step S12 and proceeds to step S14.

In step S14, the hybrid ECU 22 determines whether the predicted travel route PR includes a specific section where the vehicle 10 is supposed to travel in the EV drive mode. As used herein, the specific section means a section included in a predetermined urban area, environmental control area, emissions control area, or noise control area. That is, the specific section is a section that is included in the predicted travel route PR and that is included in the predetermined urban area, environmental control area, emissions control area, and noise control area. When YES in step S14, the routine proceeds to step S16. When NO in step S14, the routine returns to step S10.

In step S16, the hybrid ECU 22 specifies required travel energy ES required for the vehicle 10 to travel in the specific section in the EV drive mode. As described above, the hybrid ECU 22 acquires from the navigation ECU 24 the required travel energies E required for the vehicle 10 to travel in each section of the predicted travel route PR in the EV drive mode. The hybrid ECU 22 then specifies the required travel energy ES for the specific section by adding up the required travel energies E for those sections determined to be the specific section.

In step S18, the hybrid ECU 22 sets a desired value for the remaining capacity of the battery 20 based on the required travel energy ES specified in step S16. As an example, the hybrid ECU 22 sets the desired value for the remaining capacity of the battery 20 to the required travel energy ES required for the vehicle 10 to travel in the specific section. As another embodiment, the hybrid ECU 22 may set the desired value for the remaining capacity of the battery 20 to a value obtained by correcting the required travel energy ES required for the vehicle 10 to travel in the specific section in consideration of an expected error etc.

In step S20, the hybrid ECU 22 determines whether the vehicle 10 has entered the specific section. When YES in step S20, the hybrid ECU 22 executes the EV drive mode (step S22). As a result, the vehicle 10 travels in the EV drive mode in the specific section. When NO in step S20, the routine proceeds to step S24 in FIG. 4 via A in FIG. 3.

When the vehicle 10 enters the specific section (YES in step S20), switching to the EV drive mode is performed even when a predetermined time has not elapsed since the last switching of the drive mode (step S22). On the other hand, as will be described in detail later, the elapse of the predetermined time since the last switching of the drive mode is a requirement for permitting switching to a drive mode selected in step S26, S36, or S38, until the vehicle 10 enters the specific section.

In step S24, the hybrid ECU 22 determines whether the actual remaining capacity of the battery 20 is larger than a threshold value. The threshold value is the sum of the desired value (in this example, the required travel energy ES for the specific section) and a predetermined margin a. The margin a is not limited to a fixed value, and may be a value uniquely defined by a predetermined procedure or calculation formula. For example, the margin a can be set in consideration of expected fluctuations in power consumption of the motor 18. When YES in step S24, the hybrid ECU 22 selects the EV drive mode as a drive mode to be executed (step S26), and the routine proceeds to step S28.

In step S28, the hybrid ECU 22 determines whether the drive mode selected in step S26 is different from the current drive mode and whether the predetermined time has elapsed since the last switching of the drive mode. The predetermined time may be an experimentally determined value or a value determined by, for example, the conditions under which the vehicle 10 is used. As described above, the driver can be relatively easily aware of the current drive mode from the display of the instrument panel in the vehicle cabin 12c, the operating state of the engine 16, etc. Therefore, the hybrid ECU 22 of the present embodiment is configured to recognize the plurality of drive modes as drive modes that are different from each other. Specifically, the hybrid ECU 22 recognizes the EV drive mode and the HV drive mode (e.g., the normal HV drive mode or the charging HV drive mode) as drive modes that are different from each other. For example, when the EV drive mode is selected while the vehicle 10 is traveling in the HV drive mode (step S26), the EV drive mode is a drive mode different from the current HV drive mode. At this time, when the predetermined time has elapsed since the last switching to the current HV drive mode, the determination result of step S28 is YES, and the hybrid ECU 22 permits switching to the EV drive mode (step S30). The vehicle 10 can thus travel in the EV drive mode in a section before the specific section when the remaining capacity of the battery 20 is large enough.

On the other hand, when the predetermined time has not elapsed since the last switching to the current HV drive mode, the determination result of step S28 is NO, and the hybrid ECU 22 prohibits switching to the EV drive mode and maintains the current HV drive mode (step S32). When the EV drive mode is selected in step S26 while the vehicle 10 is traveling in the EV drive mode, the hybrid ECU 22 does not need to switch the drive mode. Therefore, the determination result of step S28 is NO, and the hybrid ECU 22 maintains the current EV drive mode (step S32).

In step S34, the hybrid ECU 22 determines whether the actual remaining capacity of the battery 20 is larger than the desired value (that is, the required travel energy ES for the specific section). When YES in step S34, the hybrid ECU 22 selects the normal HV drive mode as a drive mode to be executed (step S36). That is, when the actual remaining capacity of the battery 20 is equal to or smaller than the threshold value that is the sum of the desired value (in this example, the required travel energy ES) and the predetermined margin a, and is larger than the desired value, the normal HV drive mode is selected as a drive mode to be executed.

In step S40, the hybrid ECU 22 determines whether the drive mode selected in step S36 is different from the current drive mode and whether the predetermined time has elapsed since the last switching of the drive mode, as in step S28. When NO in step S40, the hybrid ECU 22 maintains the current drive mode (step S46). The hybrid ECU 22 not only recognizes the EV drive mode and the HV drive mode (e.g., the normal HV drive mode or the charging HV drive mode) as drive modes that are different from each other, but also recognizes the normal HV drive mode and the charging HV drive mode as drive modes that are different from each other, although the present disclosure is not particularly limited to this. The current drive mode (in this example, the EV drive mode or the charging HV drive mode) is maintained, so that switching to the normal HV drive mode is prohibited (step S46).

When YES in step S40, the hybrid ECU 22 determines whether the distance from the point where the vehicle 10 is located to the specific section is equal to or greater than a predetermined distance (step S42). The predetermined distance is determined based on, for example, the time it takes for the vehicle 10 to enter the specific section. As an example, the predetermined distance may be an experimentally determined value or a value determined by, for example, the conditions under which the vehicle 10 is used. When the vehicle 10 is located at less than the predetermined distance from the specific section, the vehicle 10 is expected to enter the specific section shortly. In this case, the determination result of step S42 is NO, and the hybrid ECU 22 maintains the current drive mode (step S46). As described above, even when the normal HV drive mode is selected based on the relationship between the actual remaining capacity of the battery 20 and the desired value, switching to the normal HV drive mode is prohibited when the vehicle 10 is located at less than the predetermined distance from the specific section.

When YES in step S42, the hybrid ECU 22 permits switching to the normal HV drive mode (step S44). The remaining capacity of the battery 20 can thus be avoided from falling to be equal to or below the desired value before the vehicle 10 enters the specific section.

When NO in step S34, the hybrid ECU 22 selects the charging HV drive mode as a drive mode to be executed (step S38). That is, when the actual remaining capacity of the battery 20 is equal to or smaller than the desired value (in this example, the required travel energy ES), the charging HV drive mode is selected as a drive mode to be executed.

In step S48, the hybrid ECU 22 determines whether the drive mode selected in step S38 is different from the current drive mode and whether the predetermined time has elapsed since the last switching of the drive mode, as in steps S28, S40. As described above, the EV drive mode, the normal HV drive mode, and the charging HV drive mode are all recognized as drive modes that are different from each other. When NO in step S48, the hybrid ECU 22 prohibits switching to the charging HV drive mode by maintaining the current drive mode (in this example, the EV drive mode or the normal HV drive mode) (step S54).

When YES in step S48, the hybrid ECU 22 determines whether the distance from the point where the vehicle 10 is located to the specific section is equal to or greater than the predetermined distance (step S50), as in step S42. When NO in step S50, the hybrid ECU 22 maintains the current drive mode (step S54). As described above, even when the charging HV drive mode is selected based on the relationship between the actual remaining capacity of the battery 20 and the desired value, switching to the charging HV drive mode is prohibited when the vehicle 10 is located at less than the predetermined distance from the specific section.

When YES in step S50, the hybrid ECU 22 permits switching to the charging HV drive mode (step S52). As described above, since the battery 20 is charged more in the charging HV drive mode than in the normal HV drive mode, the remaining capacity of the battery 20 can further be increased by executing the charging HV drive mode. Therefore, when the actual remaining capacity of the battery 20 is equal to or smaller than the desired value, the remaining capacity of the battery 20 can be increased before the vehicle 10 enters the specific section. The process of steps S48 to S54 is similar to the process of steps S40 to S46.

Referring back to FIG. 3, in step S56, the hybrid ECU 22 determines whether an assistance end condition is satisfied. The assistance end condition includes, for example, that an instruction or operation has been performed by the user, the vehicle 10 has come to a stop, etc. When NO in step S56, the routine returns step S10, and the hybrid ECU 22 repeatedly performs the series of control operations shown in FIGS. 3 and 4. When YES in step S56, the hybrid ECU 22 ends this series of control operations.

As described above, in the vehicle 10 of the present embodiment, when the predicted travel route PR includes a specific section where the vehicle 10 is supposed to travel in the EV drive mode, the required travel energy ES required for the vehicle 10 to travel in the specific section in the EV drive mode is specified (step S16). The desired value for the remaining capacity of the battery 20 is then set based on the specified required travel energy ES (step S18). The drive mode to be executed is determined from the plurality of drive modes based on the relationship between the actual remaining capacity of the battery 20 and the desired value (step S26, S36, S38), until the vehicle 10 enters the specific section, that is, as long as NO in step S20. The remaining capacity of the battery 20 can thus be controlled so that the remaining capacity will be equal to or larger than the desired value when the vehicle 10 enters the specific section.

In addition to the above, when the predetermined time has not elapsed since the last switching of the drive mode (NO in step S28, S40, S48), switching between the EV drive mode and the HV drive mode is prohibited regardless of the relationship between the actual remaining capacity of the battery 20 and the desired value (steps S32, S46, S54). Therefore, frequent switching between the EV drive mode and the HV drive mode can be reduced or avoided even when, for example, the remaining capacity of the battery 20 is close to the desired value. This can reduce or avoid causing discomfort to the driver.

For example, depending on the configuration of the vehicle 10 and/or the method for controlling the vehicle 10, it is sometimes difficult for the driver to recognize the difference between the normal HV drive mode and the charging HV drive mode. In such a case, switching between the normal HV drive mode and the charging HV drive mode is less likely to cause discomfort to the driver. Therefore, as a modification of the present technique, the hybrid ECU 22 may recognize both the normal HV drive mode and the charging HV drive mode as an HV drive mode. Both the normal HV drive mode and the charging HV drive mode are thus recognized as an HV drive mode, and these HV drive modes and the EV drive mode are recognized as drive modes that are different from each other. As a result, switching between the normal HV drive mode and the charging HV drive mode is regarded as switching in the HV drive mode. That is, the HV drive mode is maintained even when switching between these HV drive modes is performed. Therefore, in this modification, when the current drive mode is the charging HV drive mode, not only the charging HV drive mode can be maintained but also the charging HV drive mode can be switched to the normal HV drive mode in step S46. Similarly, when the current drive mode is the normal HV drive mode, not only the normal HV drive mode can be maintained but also the normal HV drive mode can be switched to the charging HV drive mode in step S54.

As another modification of the present technique, the hybrid ECU 22 may perform the process of determining whether to allow switching of the drive mode (or a part of this process) before selecting the drive mode based on the relationship between the actual remaining capacity of the battery 20 and the desired value in the series of control operations shown in FIGS. 3 and 4.

For example, the hybrid ECU 22 may perform the process of determining whether the predetermined time has elapsed since the last switching of the drive mode (that is, a part of step S28, S40, S48) before step S24. In this case, the hybrid ECU 22 selects a drive mode to be executed based on step S24 (or step S34) when the hybrid ECU 22 determines that the predetermined time has elapsed since the last switching of the drive mode. For example, when YES in step S24 and the EV drive mode is selected as a drive mode to be executed (step S26), the hybrid ECU 22 executes the EV drive mode. On the other hand, when the hybrid ECU 22 determines that the predetermined time has not elapsed since the last switching of the drive mode, the hybrid ECU 22 maintains the current drive mode without performing step S24. That is, since the predetermined time has not elapsed since the last switching of the drive mode, switching of the drive mode is prohibited.

In addition to the above, the hybrid ECU 22 may also perform the process of determining whether the distance from the point where the vehicle 10 is located to the specific section is equal to or greater than the predetermined distance (step S42, S50) before step S34. In this case, when the hybrid ECU 22 determines that the distance from the point where the vehicle 10 is located to the specific section is equal to or greater than the predetermined distance (YES in step S42, S50), the hybrid ECU 22 selects a drive mode to be executed, based on step S34. At this time, when the hybrid ECU 22 has determined that the predetermined time had elapsed since the last switching of the drive mode, the hybrid

ECU 22 can execute the normal HV drive mode (step S36) or the charging HV drive mode (step S38) based on step S34. On the other hand, when the hybrid ECU 22 determines that the distance from the point where the vehicle 10 is located to the specific section is smaller than the predetermined distance (NO in step S42, S50), the hybrid ECU 22 maintains the current drive mode without performing step S34. That is, since the vehicle 10 is located at less than the predetermined distance from the specific section, switching of the drive mode is prohibited.

Alternatively, instead of the above, the hybrid ECU 22 may perform step S42, S50 before step S34.

While some specific examples are described in detail above, these are merely illustrative and are not intended to limit the scope of the claims. The technique described in the claims includes various modifications and alterations of the specific examples illustrated above. The technical elements illustrated in the present disclosure or in the drawings exhibit technical utility alone or in combination.

What is claimed is:

1. A hybrid electric vehicle, comprising:
a motor for traction;
an engine;
a battery configured to supply driving electric power to the motor and configured to be charged with electric power generated by the motor; and
a controller configured to be able to control the motor and the engine and configured to selectively execute a plurality of drive modes,
wherein the drive modes include at least an electric drive mode in which the hybrid electric vehicle runs on the motor with the engine stopped, and a hybrid drive mode in which the hybrid electric vehicle runs on the engine and/or the motor with the engine in operation,
wherein the controller is configured to be able to perform an acquiring process, a specifying process, a setting process, and a determining process,
wherein the acquiring process is a process of acquiring a predicted travel route,
wherein the specifying process is a process of, when the predicted travel route includes a specific section where the hybrid electric vehicle is supposed to travel in the electric drive mode, specifying required travel energy required for the hybrid electric vehicle to travel in the specific section in the electric drive mode,
wherein the setting process is a process of setting a desired value for a remaining capacity of the battery based on the specified required travel energy,
wherein the determining process is a process of determining a drive mode to be executed from the drive modes based on a relationship between an actual remaining capacity of the battery and the desired value, until the hybrid electric vehicle enters the specific section, and
wherein the controller is configured to, in the determining process, prohibit switching between the electric drive mode and the hybrid drive mode regardless of the relationship when a predetermined time has not elapsed since last switching of the drive mode.

2. The hybrid electric vehicle according to claim 1, wherein the controller is configured to, in the determining process, prohibit switching from the electric drive mode to the hybrid drive mode regardless of the relationship when the hybrid electric vehicle is located at less than a predetermined distance from the specific section.

3. The hybrid electric vehicle according to claim 1, wherein the controller is configured to, in the determining process, select the electric drive mode when the relationship is that the actual remaining capacity of the battery is at least larger than the desired value.

4. The hybrid electric vehicle according to claim 1, wherein the controller is configured to, in the determining process, select the electric drive mode when the relationship is that the actual remaining capacity of the battery is larger than a threshold value, and select the hybrid drive mode when the relationship is that the actual remaining capacity of the battery is equal to or smaller than the threshold value, the threshold value being a sum of the desired value and a predetermined margin.

5. The hybrid electric vehicle according to claim 4, wherein:
the hybrid drive mode includes a normal hybrid drive mode and a charging hybrid drive mode in which the battery is charged more than in the normal hybrid drive mode; and
the controller is configured to, in the determining process, select the normal hybrid drive mode when the relationship is that the actual remaining capacity of the battery is larger than the desired value, and select the charging hybrid drive mode instead of the normal hybrid drive mode when the relationship is that the actual remaining capacity of the battery is equal to or smaller than the desired value.

6. The hybrid electric vehicle according to claim 5, wherein the controller is configured to, in the determining process, also prohibit switching between the normal hybrid drive mode and the charging hybrid drive mode regardless of the relationship when the predetermined time has not elapsed since the last switching of the drive mode.

7. The hybrid electric vehicle according to claim 1, wherein the specific section is a section included in a predetermined urban area, environmental control area, emission control area, or noise control area.

8. The hybrid electric vehicle according to claim 1, wherein the controller is configured to, when the hybrid electric vehicle enters the specific section, perform switching to the electric drive mode even when the predetermined time has not elapsed since the last switching of the drive mode.

9. A method for controlling a hybrid electric vehicle, the hybrid electric vehicle including a motor for traction, an engine, and a battery configured to supply driving electric power to the motor and configured to be charged with electric power generated by the motor, the method comprising:
controlling the motor and the engine;
selectively executing a plurality of drive modes, the drive modes including at least an electric drive mode in which the hybrid electric vehicle runs on the motor with the engine stopped, and a hybrid drive mode in which the hybrid electric vehicle runs on the engine and/or the motor with the engine in operation;
acquiring a predicted travel route;
when the predicted travel route includes a specific section where the hybrid electric vehicle is supposed to travel in the electric drive mode, specifying required travel energy required for the hybrid electric vehicle to travel in the specific section in the electric drive mode;
setting a desired value for a remaining capacity of the battery based on the specified required travel energy;
determining a drive mode to be executed from the drive modes based on a relationship between an actual remaining capacity of the battery and the desired value, until the hybrid electric vehicle enters the specific section; and
prohibiting switching between the electric drive mode and the hybrid drive mode regardless of the relationship when a predetermined time has not elapsed since last switching of the drive mode.
